(19) United States
(12) Patent Application Publication
(10) Pub. No.: US 2014/0278757 A1
(43) Pub. Date: Sep. 18, 2014

(54) METHOD AND APPARATUS FOR LEAD GENERATION

(71) Applicants: Charles E. BAKER, Pacific Palisades, CA (US); Mark J. STECKEL, San Francisco, CA (US)

(72) Inventors: Mark J. STECKEL, San Francisco, CA (US); Charles E. BAKER, Pacific Palisades, CA (US)

(21) Appl. No.: 14/206,242

(22) Filed: Mar. 12, 2014

Related U.S. Application Data
(60) Provisional application No. 61/784,998, filed on Mar. 14, 2013.

(51) Int. Cl. G06Q 30/02

(52) U.S. Cl. CPC G06Q 30/0201
USPC 705/7.29

(57) ABSTRACT

A non-transitory computer-readable medium including program code stored thereon is provided which, when executed by a computer, causes the computer to perform the operations of: receiving a request for an input form for display on an electronic interface, each input form including at least one information request and an associated data input field; and selecting the input form for display on the electronic interface from among a set of input forms, wherein each input form of the set of input forms differs from all other input forms of the set of input forms, and which input form of the set of input forms is selected in response to separate requests for input forms is varied based on a test instruction.

### BACKGROUND

1. Field of the Invention

This invention relates to electronic commerce and in particular to a method and apparatus for dynamically improving customer lead generation.

2. Related Art

Marketing and sales efforts that are focused on the set of potential customers most likely to purchase a vendor's products or services are typically much more cost-effective than advertising to the general population. A sales lead, or lead, is a potential customer who has indicated an interest in a vendor's products or services. Lead generation is the process of creating and identifying sales leads. Lead generation is a necessary part of direct marketing, and effective lead generation can significantly improve direct marketing and sales efforts. Lead generation is often most useful if information in addition to the identity and contact information for the potential customer is collected. Such additional information can be used to tailor the sales and marketing efforts to the particular interests of the sales lead, to enhance the probability of a sale.

Electronic commerce, for instance via the internet, is increasingly being used as a medium for lead generation. Internet portals offer vendors the opportunity to mass-market to large audiences. Within the portal web site, however, visitors may also be asked if they would like to provide their contact and other information in exchange for something, for example, being contacted by a sales person, a brochure with additional information, coupons, etc. To provide the information, the visitor to the site typically enters information into an electronic form, sometimes referred to as a landing page, and a lead is generated containing the information entered into the electronic form. This lead is then delivered to the vendor.

One of the problems with these methods for lead generation is that there is often a low lead to sale conversion rate, meaning that while a large number of people may have completed the electronic form, resulting in a large number of leads, very few of the leads result in an actual sale.

### SUMMARY

In one aspect, a non-transitory computer-readable medium including program code stored thereon is provided which, when executed by a computer, causes the computer to perform the operations of: receiving a request for an input form for display on an electronic interface, each input form including at least one information request and an associated data input field; and selecting the input form for display on the electronic interface from among a set of input forms, wherein each input form of the set of input forms differs from all other input forms of the set of input forms, and which input form of the set of input forms is selected in response to separate requests for input forms is varied based on a test instruction.

Each input form of the set of input forms may differ by at least one information request and associated data input field.

Each input form of the set of input forms may differ by a sequence in which two or more information requests and associated data input fields are presented.

The non-transitory computer-readable medium may further include program code stored thereon which, when executed by a computer, causes the computer to perform the operations of: recording, for each input form in the set of input forms, each time the input form is selected and provided to the electronic interface; and recording, for each input form, whether or not data is entered into the data input field and submitted.

The non-transitory computer-readable medium may further include program code stored thereon which, when executed by a computer, causes the computer to perform the operations of: receiving and storing data entered into the data input field of the selected input form.

The test instruction may include a weight for each input form in the set of input forms, the weight determining a frequency at which an input form is selected.

The test instruction may include a random selection algorithm.

The non-transitory computer-readable medium may further include program code stored thereon which, when executed by a computer, causes the computer to perform the operations of: associating a test identifier with the set of input forms and the test instruction.

The request may include the test identifier.

The non-transitory computer-readable medium may further include program code stored thereon which, when executed by a computer, causes the computer to perform the operations of: modifying input forms included in the set of input forms without modifying the associated test identifier.

The non-transitory computer-readable medium may further include program code stored thereon which, when executed by a computer, causes the computer to perform the operations of: modifying the test instruction without modifying the associated test identifier.

The test identifier may be a Javascript tag.

The non-transitory computer-readable medium may further include program code stored thereon which, when executed by a computer, causes the computer to perform the operations of: recording, for each input form in the set of input forms, each time the input form is selected and provided to the electronic interface and the test identifier.

The non-transitory computer-readable medium may further include program code stored thereon which, when executed by a computer, causes the computer to perform the operations of: recording, for each input form, whether or not data is entered into data input field and submitted and the test identifier.

The non-transitory computer-readable medium may further include program code stored thereon which, when executed by a computer, causes the computer to perform the operations of: determining a response ratio for each input form of the set of input forms, wherein the response ratio is a ratio of a number of times data is entered into the data input field and submitted for an individual input form to a number of times the individual input form is displayed.

The non-transitory computer-readable medium may further include program code stored thereon which, when executed by a computer, causes the computer to perform the operations of: providing a user interface that allows a user to generate one or more input forms, choose the set of input forms, and generate the test instruction for the set of input forms.

The electronic interface may include a web page.

In another aspect, a lead generation system includes: one or more processors; a memory accessible by the one or more processors; and a test configuration function using the one or more processors and memory, the test configuration function including a set of input forms for display on an electronic interface, each input form including at least one information request and an associated data input field, wherein each input form of the set of input forms differs from all the other input forms of the set of input forms, the test configuration function configured to, in response to a request to display an input form on the electronic interface, select an input form from among the set of input forms, the test configuration function varying which form of the set of input forms is selected in response to separate requests based on a test instruction.

The lead generation system may further include: a database configured to record, for each input form in the set of input forms, a number of times the input form is displayed and a number of times data is entered and submitted via the data input field.

Each input form of the set of input forms may differ by the at least one information request and associated data input field.

The lead generation system may further include a test identifier associated with the test configuration function, wherein the request to display an input form includes the test identifier.

The lead generation system may further include: a database configured to record, for each input form in the set of input forms, a number of times the input form is displayed and a number of times data is entered and submitted via the data input field and the associated test identifier.

The test instruction may include an algorithm, and each input form of the set of input forms may have an associated weight, the weight determining a frequency at which an input form is selected.

In another aspect, a computer implemented method for lead generation is provided, the method including: receiving a request from an electronic interface for an input form for display on the electronic interface, each input form including at least one information request and an associated data input field; and selecting the input form for display on the electronic interface from among a set of input forms, wherein each input form of the set of input forms differs from all the other input forms of the set of input forms, and which input form of the set of input forms is selected in response to separate requests for input forms is varied based on a test instruction.

Each input form of the set of input forms may differ by the at least one information request and associated data input field.

The test instruction may include an algorithm and a weight associated with each input form, the weight determining a frequency with which each input form of the set of input forms is selected.

The method may further include: recording, for each input form in the set of input forms, each time the input form is selected and provided to the electronic interface; and recording, for each input form, whether or not data is entered into the data input field and submitted.

The method may further include: associating a test identifier with the test instruction and set of input forms, wherein the request includes the test identifier.

The method may further include inserting the test identifier into a controlling system for the electronic interface.

The controlling system may be a computer hosting a web site and the test identifier may be a Javascript tag embedded into the web site.

In another aspect, a computer-implemented method for lead generation is provided, the method including: in response to a request from an electronic interface, providing an input form to the electronic interface, the input form including an information request and associated data input field, wherein the input form provided in response to the request has been tested using a test function in which different input forms of a set including the input form, each input form in the set having different information requests and associated data input fields, were provided in response to separate requests based on a test instruction.

In another aspect, a non-transitory computer-readable medium having program code stored thereon is provided, the program code, when executed by a computer, causes the computer to perform the operations of: sending a request for an input form from an electronic interface, wherein the input form includes an information request and associated data input field for display on the electronic interface; and receiving the input form in response to the request, wherein the input form received in response to the request was selected from among a set of input forms using a test instruction.

The program code may include a test identifier associated with the set of input forms, and sending the request includes sending the test identifier.

The test identifier may be a Javascript tag.

In another aspect, a non-transitory computer-readable medium having program code stored thereon is provided, which is accessible to a user controlling a customer interface, the program code, when executed by a computer, causes the computer to perform the operations of: assigning one or more different input forms to a test configuration function, each input form including at least one information request and an associated data input field for display on the customer interface; and assigning one or more test instructions to the test configuration function, the test instructions varying which input form of the different input forms assigned to the test configuration is selected in response to separate input form requests from the customer interface.

The non-transitory computer-readable medium may further include program code stored thereon which, when executed by a computer, causes the computer to perform the operations of: creating a test identifier associated with the test configuration function.

The test identifier may be a Javascript tag.

The non-transitory computer-readable medium may further include program code stored thereon which, when executed by a computer, causes the computer to perform the operations of: modifying the input forms assigned to the test configuration function without modifying the test identifier.

The non-transitory computer-readable medium may further include program code stored thereon which, when executed by a computer, causes the computer to perform the operations of: modifying the test instruction assigned to the test configuration function without modifying the test identifier.

### BRIEF DESCRIPTION OF THE DRAWINGS

FIG. 1A is a block diagram showing overview of an embodiment of a lead generation system and the relationship of the lead generation system to system users and customers.

FIG. 1B illustrates an embodiment of the operation of lead generation system with system user.

FIG. 1C illustrates an embodiment of a lead generation system that includes a user management tool, a test retrieval process, and a form submission process.

FIG. 2 a block diagram illustrating the functions provided in the user management tool.

FIG. 3 illustrates an embodiment of a method for implementing testing.

FIG. 4 is a flow diagram illustrating an embodiment for the test retrieval process.

FIG. 5 a flow diagram illustrating an embodiment for the form submission process.

FIG. 6 illustrates an embodiment of how the different types of data objects are related to each other.

FIGS. 7A-7P show screen views of the various functions of the user management tool.

FIG. 8 depicts a high-level block diagram of physical components that may be used for an embodiment of lead generation system.

### DETAILED DESCRIPTION

One of the difficulties with lead generation via electronic commerce, and a likely cause of the low lead to sales conversion rate, is that it is assumed that the more information the visitor to the site is asked to enter, the less likely it will be that the person completes and submits the form. Determining which information is most useful to ask for, and how much and what information can be requested before a potential customer decides not to provide any information, is difficult to ascertain, and often involves use of sales and marketing teams to develop a strategy based on experience and guesswork. The lead generation system disclosed herein provides a data-driven solution to this problem, and can improve the click to lead conversion rate, which may be used to increase lead to sales conversions.

In addition, modifying an input form that is viewed and collects customer information via a website or other electronic interface currently requires direct modification to the code controlling the website or other electronic interface and also to the database or other medium used to store any information received in response to the form. Such modifications can be costly and time-consuming, and prevents meaningful testing and data collection on the outcomes of various different forms. The lead generation system disclosed herein provides a easy and cost-effective method for modifying input forms

FIG. 1A is a block diagram showing overview 100 of an embodiment of a lead generation system 110, described in more detail below, and the relationship of the lead generation system 110 to system users 120, and customers 130. System users 120 include anyone, for example, vendors, who use the lead generation system 110. System users 120 are connected to the lead generation system 110, for example via the internet. System users 120 have an electronic interface 122, which may be, for example, a web page, an interactive display at an in-store kiosk, or the like, that various customers 130 can interact with. Customers 130 are individuals who view the electronic interface 122, and optionally submit information through the electronic interface 122, via input forms 123 as described below. Although lead generation system 110 is shown in FIG. 1A as a separate system from the system users 120, and having multiple system users 120, lead generation system 110 may alternatively be used with a single system user 120, and may be integrated with the software providing the electronic interface 122.

FIG. 1B illustrates an embodiment of the operation of lead generation system 110. Lead generation system 110 creates different forms to be shown as input form 123 to different customers 131-138. In the example shown in FIG. 1B, two forms are created, illustrated in FIG. 1B as “A” and “B.” The forms A and B in this example differ in the content that they request, i.e., form A will ask one question or set of questions and form B will ask a different question or set of questions. As will be described in more detail below, the system user 120 can determine the content to be requested in each different form, as well as other variations to the forms.

When a customer 131-138 makes a request to view the electronic interface 122, for instance by selecting a web page, a form, which will be displayed as input form 123, is requested from lead generation system 110. The lead generation system 110, upon receiving the request, chooses a form, in this example form A or B, from a set of forms, assigned to a test configuration as will be described in more detail below. The chosen form is displayed as input form 123 to the particular customer 131-138. In most cases, only a portion of customers 131-138 decide to submit information via the input form 123. In the example in FIG. 1B, customers 132, 134, 136 and 138, which are indicated with an asterisk “*” submit information. When customers 132, 134, 136 and 138 submit information via input form 123, the information provided by the customer 130 is sent back to the lead generation system 110 and collected by the lead generation system 110, for example in a database 140.

For a series of different customers 131-138 each viewing one of the different input forms “A” and “B”, the lead generation system 110 collects data on which of the different input forms results in the customers 131-138 submitting information via the input form. Lead generation system 110 also collects and stores the information the customers 132, 134, 136 and 138 submit. Thus, lead generation system 110 enables the comparison of data submission response rates by customers 131-138 to dynamically rendered input forms 123, and does so based on a modifiable test configuration that can be, as will be described below, set by the system user 120. The lead generation system 110 can analyze the collected data to determine, for example, which forms result in the highest number of leads, as shown in 140. The data and information collected by the lead generation system 110 are provided to the system user 120. Lead generation system 110 allows a very large amount of such data 140 to be collected, allowing statistically significant analysis to be performed using the data 140. The lead generation system 110 also collects data on a) if a customer 131-138 starts to enter information into an input form 123 but then does not submit the input form 123, and b) the duration of time from when the form is first displayed to when the customer starts to enter information into the input form 123.

The data collected by the lead generation system can also be correlated with sales and other data 150, which may reside within the lead generation system 110 or which may reside with the system user 120. As shown in FIG. 1B, the integrated data 150 can be used to analyze which input form A or B resulted in an actual sale. In the example shown, form “A” for customer 138 resulted in a sale, possibly indicating that information collected in form “A” is useful for closing a sale.

FIG. 1C illustrates an embodiment of a lead generation system 110 that includes a user management tool 200, which allows a system user 120 to interact with the lead generation system 110, a test retrieval process 400, for selecting and displaying input forms according to a test configuration, and a form submission process 500, for collecting information submitted by customers 130. The user management tool 200, test retrieval process 400 and form submission process 500 will each be described in more detail below.

Lead generation system 110 can include a user management tool 200, an embodiment of which is illustrated in FIG. 2. Each system user 120, which may be, for example, a vendor client of the lead generation system 110, is provided with access to the user management tool 200, and the specific data of each system user 120 is stored separately and accessible only by individuals belonging to the system user 120 who have been granted access by system user 120 (for example, by password protected entrance to the user management tool 200). Individuals granted access under one system user 120 are prohibited from accessing the data and forms of other system users 120.

FIG. 2 is a block diagram illustrating the functions provided in the user management tool 200 and their interaction. A system user 120 uses the user management tool 200 to create different forms 220, 221, 222 and one or more test configurations 242 that can be used for testing the forms. The user management tool 120 provides a function for selecting questions from a set of predetermined questions 202 for inclusion into one or more of the forms 220, 221, 222. Such predetermined questions 202 may include, for example, name, e-mail address, phone number, etc., which would be commonly included in a form for collecting lead information. The user management tool 200 also provides a custom question input function 204 that allows the system user 120 to input one or more custom question that can be selected for addition into one or more of the forms 220, 221, 222.

At S215 the user management tool 200 allows the user to create forms 220, 221, 222 by selecting questions 202 and/or custom questions 204 for inclusion in one or more of the forms 220, 221, 222. Each form 220, 221, 222 usefully can differ by one or more question. For example, form 220 may include a request for an e-mail address, form 221 may include a request for name, address, phone, e-mail address, and form 223 may include a request for an e-mail address and a custom question, such as which model of a vendor's products the person is most interested in. Usefully, two or more different forms are created, but user management tool 200 will also allow just one form to be created. User management tool 200 also allows different forms to contain the exact same questions, but permits, for example, the questions to appear in a different order and/or changes which question requires a response from the customer 130 for successful form submission. Forms may also differ in appearance, and for example, element size, color, fonts, etc. between forms may be different. It is also possible to create just one form for use in testing. For example, a system user 120 may want to use just one form in a test and view how response rate changes over time for that one form, or if a modification is made to the single form (such change in response rate data is also be collected when a test contains multiple forms). In FIG. 2, forms 220, 221 and 222 are provided by way of example, with form 222 in dashes indicating that the number of forms that are created is variable.

At S225 testing function 240 is used to create tests that include one or more of the forms 220, 221, 222. Testing function 240 provides the system user 120 with the ability to define one or more test configurations 242. A test configuration 242 sets parameters for deciding which of the forms 220, 221, 222 will be displayed to a customer 130. The testing function 240 allows the user 120 to select which of the different forms 220, 221, 222 to be assigned to the particular test configuration 242, and allows user 120 to assign a weight to each form. The weight is used to determine how frequently to display one of the forms (e.g., 220) in comparison to the other forms (e.g., 221) assigned to the test configuration 242. A test configuration 242 may also include other parameters, for example, which random selection algorithm to be used for random selection of the included forms. Thus, a test configuration 242 may include a set of instructions to form a test that is, for example, an A/B or split-type of test, in which two forms are used, differing, for instance, by one question, and equally weighted. Or in another example, a test configuration 242 may include a set of instructions for a multivariate-type test, where various forms are used with variable weightings. The process for creating forms at S215 is independent of the process of creating test configurations 242 at S225 in that a test configuration 242 does not need to use all of the forms 220, 221, 222 created, and the same form may be used by more than one test configuration 242.

While forms 220, 221 and 222 have been described in terms of an individual form for each, alternatively, a form may include a sequence of forms to be displayed. That is, if an initially displayed form is completed and submitted by the user (via form submission process 500 outlined below), the test configuration 242 may be set to instruct that a second form may be retrieved and displayed requesting additional information from the customer 130. Such a process may be repeated, and data is collected, as described below, for each of the sequentially displayed forms.

Each testing configuration 242 includes a unique identifier, test identifier 244, associated with that testing configuration 242. At S235, once a test configuration 242 has been created, its test identifier 244 can be retrieved. The test identifier 244 is used to retrieve its associated test configuration 242 when a form is requested, as described below with respect to FIG. 4. One mechanism of utilizing the test identifier 244 is via a tag 245 that incorporates the test identifier 244. The testing function 240 can generate a tag 245, for instance a Javascript tag, which includes the test identifier 244. The tag 245 can be embedded into the HTML of web page at the system user 120.

The user management tool 200 also includes a dashboard and report function 290 that the system user 120 may use to view data collected by lead generation system 110. An implementation of dashboard and report function 290 is illustrated below with respect to FIGS. 7N-7P. System users can view data on the rate of submission (i.e., the response rate) to different forms, and can also see data on how, if a form is changed, the response rate and information collected changes after a form is changed.

FIG. 3 illustrates an embodiment of a method 300 for implementing testing. In this example, the system user 120 has a web site 305 that is used for the electronic interface 122 (FIG. 1). The tag 245, which in this example is a Javascript tag, created by the testing function 240 is displayed by the user management system 200. The tag 245 can be copied and pasted S301 into Javascript 304 controlling the system user's web site 305, and in particular into the Javascript controlling the system user's web page 122 used to display input form 123. In general, any method that is capable of inserting the test identifier 244 into the controlling system and software for electronic interface 122, so that the test identifier 244 can be used to retrieve a form through its associated test configuration 242 for display on the electronic interface 122 may be used. For example, if the lead generation system 110 is integrated with the system user's code controlling the electronic interface 122, the tag may be automatically inserted into the code.

FIG. 4 is a flow diagram illustrating an embodiment for the test retrieval process 400 performed by the lead generation system 110 when a customer 130 accesses electronic interface 122 that displays a form 123. At S401, the request, which includes the test identifier 244, is sent to the lead generating system 110. The request sent to the lead generation system 110 includes the test identifier 244 and may include additional data, including without limitation IP address, referring domain, browser and version, from the electronic interface 122 from which the request originates. At S403 the test configuration 242 associated with test identifier 244 is retrieved, and the identifier for the system user 120 associated with the test identifier may also be retrieved. At S405 the lead generation system 110 determines if the system user 120 and the test configuration 242 are still active. The system user 120 and the test configuration 242 must both be active for processing to continue. If both are active, at S409 the test configuration 242 retrieves the forms 220, 221, 222 that are assigned to the test configuration 242 along with any additional parameters and data assigned to the test configuration 242.

At S411 the number of forms assigned to the retrieved test configuration 242 is counted and if it has only one form, then the form is returned. If the test configuration 242 has more than one form, then at S413 one of the assigned forms 220, 221, 222 is randomly chosen based on the weight assigned to each form 220, 221, 222 within the set and the selection algorithm associated with the test configuration 242. The lead generation system 110 then retrieves the questions and any other data assigned to the selected form at S415.

Test retrieval process 400 performs S417, S419 and S421 in any order. At S417, the selected form with associated questions is returned to the requestor for presentation to the customer 130. The form may be returned, for example, as pre-rendered HTML (plus optional CSS and/or Javascript), but any suitable format may be used, including without limitation JSON. Alternatively, the form may be returned as data describing the form, associated questions and other attributes for assembly and rendering by the requestor (which may be a web browser). Additional data may be included, for example a unique session identifier for the requestor, the test identifier 244, and identifiers for the form and/or questions used by the lead generation system 110. Such additional data may be used to facilitate processing of form submissions as described below with respect to FIG. 5.

At S419, the request is logged and statistics are updated including, but not limited to, data for the test configuration 242, the form chosen, the site originating the request, information about the customer 130 including IP address, and the date and time of the request. Session state data is saved at S421 to facilitate processing of subsequent form submissions from the requestor.

Once a customer 130 has been presented with input form 123 via the process of FIG. 4, the consumer may choose to enter data, which are answers to the questions associated with the presented form, into the form fields and submit the completed form, or partially completed form as all of the form fields may not be required.

FIG. 5 is a flow diagram illustrating an embodiment for the form submission process 500 performed by the lead generation system 110 when a customer 130 submits a form.

At S502 the form is submitted. The submission includes data entered by the customer, a unique session identifier representing the requestor and possibly other data, including without limitation the IP address, referring domain, browser make and version. Note that the session identifier, IP address referring domain, browser make and version may have been saved at S401 when provided with the request. At S504 the lead generation system 110 receives the submission. At S506, the lead generation system 110 retrieves data associated with the supplied unique session identifier. If, at S508, the submission did not include a unique session identifier or no data exists for the supplied unique session identifier, then an empty response is returned and processing completes at S510.

At S512, the form that was displayed to the customer 130 is retrieved along with, at S514, the questions associated with the form. At S516 the data submitted by the customer 130 is checked for validity based on the current form definition and the assigned questions. When the system validates the form, it checks a) if data for required fields are present and b) the format of data for the entered fields. For example, if a phone number is the requested data, the data can be checked to verify that it includes the correct number of digits, etc. If validation fails at S518, a response including the form associated with the test identifier, user submitted data and error notification is created and sent at S522 to the input form 123 in interface 122 for completion by the customer 130. The process is repeated at S524.

If the data submitted is validated at S526 then the lead generation system 110 performs one or more of S528, S530, S532, and S534. At S528 the consumer submitted data is stored and recorded as a lead. At S530 the completed form submission is logged and statistics are updated including but not limited to data for the test configuration 242, the form used with the particular session, the site originating the request, information about the customer 130 and the IP address, date and time of the request. At S532, the state information may be reset. At S534 a response may be sent to the customer 130, for example a thank you or other message, any promised material, such as a digital brochure, or a URL to which the customer is redirected. Alternatively, if a sequential form it to be used, the next form in the sequence may be sent to the customer 130, and then, if the completed form is submitted, form submission process 500 is repeated.

Once a lead has been stored in the lead generation system 110 further processing of the lead may occur including but not limited to a) reporting the lead, b) downloading of the lead by the client/system user 120, c) automatic or manual delivery to a destination specified by the client/system user 120, d) processing and/or routing in nearly any manner based upon the lead data, the source of the lead or any other data, e) correlated with customer sales conversation data. Transmission of the lead data may occur using any mechanism or technology.

A specific implementation for a data object structure useful in implementing the lead generation system 110 is illustrated in FIG. 6 and Table 1, below. In Table 1, “Data Objects” refers to primary objects of the lead generation system 110 and “Description” refers to their primary attributes. In Table 1, the “Client” is, for example, the entity that is the system user 120 of lead generation system 110 and the “User” refers to the persons at the Client who can access and use the lead generation system 110 for the Client. The “Question” is as described with respect to FIG. 2 question 202 and custom question 204 functions and “Form” corresponds to forms 220, 221, 222. The “Form Questions” data object relates the Questions to the Forms. The “A/B Test” is the test configuration 242 set in the testing function 240. The “A/B Test Forms” relates the A/B Test, via the test identifier 244, to the Forms. The “Lead” connects the lead information provided by the customer 130 to the A/B Test and the Form.

TABLE 1

| Data Object | Description |
|---|---|
| Client | id |
| | name |
| | address(es) |
| | master user id (the “admin” account for the client) |
| User | id |
| | client_id |
| | email, |
| | name |
| | permissions |
| Question | id |
| | client_id |
| | parent_id |
| | name |
| | type |
| | validation rule (optional) |
| | choices if type is multiple choice |
| Question Choices | id |
| | question_id |
| | choice id |
| Choice | id |
| | name |
| | value |
| Form | id |
| | client_id |
| | name |
| | campaign |
| | custom CSS |
| | custom Javascript |
| Form Questions | id |
| | form_id |
| | question_id |
| | position |
| | required |
| A/B Test | id |
| | client_id |
| | name |
| A/B Test Forms | id |
| | ab_test_id |
| | form_id |
| Lead | id |
| | date |
| | ip address |
| | ab_test_id |
| | form_id |
| | data (the data submitted by the consumer, e.g., |
| | name, address, phone, etc.) |

FIG. 6 illustrates an embodiment of how the different types of data objects outlined in Table 1 are related to each other. The arrows in FIG. 6 point from the id for the data object to the data object itself. The data objects are most usefully stored such that they can later be retrieved. As can be seen in FIG. 6, from the id for the A/B Test, test configuration data can be retrieved and executed to obtain form and question data, so that a dynamically rendered form according to the test configuration can be displayed. FIG. 6 also illustrates that data returned in response to the A/B Test may be stored with the id for the A/B Test, as a lead.

Any storage mechanism/technology may be used to store the data objects, including but not limited to SQL databases, NoSQL databases, memory storage files, file system storage, and the like, as are known to those of ordinary skill in the art. Any method may be used for accessing and using the stored data objects in connection with the lead generation system 110, including without limitation internet applications, mobile applications, client-server applications, command line programs, direct database queries, and the like, as are known to those of ordinary skill in the art.

FIGS. 7A-7P are screen shots from an implementation of the user management tool 200.

FIGS. 7A and 7B are examples of two different forms requesting different information via different questions. The form shown in FIG. 7A includes five fields for the system user to submit data (fields), three of which—“Full name,” “Zipcode,” and “Email”—are indicated by the asterisk as being required. The form shown in FIG. 7B includes two fields, both of which—“Email” and “Full name”—are indicated as required. The two forms can be associated with and displayed via the same tag 245, and data submission rates based on number and type of fields in the forms can be determined.

FIG. 7C shows the same form as in the previous image 7B, except with the requests presented in a different order, which is an option in this implementation of the user management tool 200.

FIG. 7D is a screen shot of what a system user 120 would see when accessing questions functionality 202.

FIG. 7E is a screen shot of what a system user 120 would see when accessing questions functionality 202 for setting up a multiple choice question in a form.

FIG. 7F is a screen shot of what a system user 120 would see when accessing custom question functionality 204.

FIG. 7G is a screenshot of what a system user 120 would see when accessing question 202 and custom question 204 functionality showing a list of available questions for the system user to choose to put into a form for a test configuration 242 (at S215 of FIG. 2).

FIG. 7H-7J are screen shots showing how forms 220, 221 and 222 may be created.

FIG. 7K is a screen show showing a set up page for a test configuration 242.

FIG. 7L is a list of test configurations 242 set up by system user 120.

FIG. 7M is a screen shot of a tag 242, in this case a Javascript tag, generated by the test function 240 as described above with respect to FIG. 2. The test identifier 244 is highlighted.

FIGS. 7N-7P are screen shots of an implementation for allowing a system user to view and use data collected by the lead generation system 110. FIGS. 7N and 7M are screen shots of a dashboard allowing the system user 120 to view data collected by the lead generation system 110. The dashboard provides an overview of activity and provides the ability to compare response rates across a number of dimensions including Forms, A/B Tests, Sites, Campaigns, etc. FIG. 7N is the top level dashboard. FIG. 7O is a dashboard showing details of the forms.

FIG. 7P is a screen shot of a form performance report. The form performance report shows the response rate and other metrics of a form over time, including before and after a form has been modified.

FIG. 8 depicts a high-level block diagram of physical components that may be used for an embodiment of lead generation system 110. As depicted in FIG. 8, the lead generation system 110 can include a processor element 802 (e.g., a CPU), a memory 804, e.g. random access memory (RAM) and/or read only memory (ROM), a module 805 for controlling the lead generation system 110, and various input/output devices 806 (e.g. storage devices, including but not limited to, a tape drive, a floppy drive, a hard disk drive or a compact disk drive, a receiver, a transmitter, a speaker, a display, a speech synthesizer, and output port, and a user input device (such as a keyboard, a keypad, a mouse, a touchscreen and the like)).

It should be noted that the present embodiments can be implemented in software and/or in a combination of software and hardware, e.g., using application specific integrated circuits (ASIC), a general purpose computer or any other hardware equivalents. In one embodiment, a module 805 controlling the lead generation system 110 can be loaded into memory 804 and executed by processor 802 to implement the functions as discussed above. As such, the module 805 of the present embodiments can be stored on a computer readable medium, e.g. RAM memory, magnetic or optical drive or diskette and the like. As will be appreciated by one of ordinary skill in the art, virtualization may allow the functions of these components to be distributed over multiple machines or multiple virtual machines.

Although example embodiments are presented herein, the invention can be practiced with modification and alteration to the embodiments that are explicitly provided without deviating from the spirit and scope of the disclosure. The description is not intended to be exhaustive or to limit the invention to the precise form disclosed.

What is claimed is:

1. A non-transitory computer-readable medium comprising program code stored thereon which, when executed by a computer, causes the computer to perform the operations of:
receiving a request for an input form for display on an electronic interface, each input form including at least one information request and an associated data input field; and
selecting the input form for display on the electronic interface from among a set of input forms, wherein each input form of the set of input forms differs from all other input forms of the set of input forms, and which input form of the set of input forms is selected in response to separate requests for input forms is varied based on a test instruction.

2. The non-transitory computer-readable medium of claim 1, wherein each input form of the set of input forms differs by the at least one information request and associated data input field.

3. The non-transitory computer-readable medium of claim 1, wherein each input form of the set of input forms differs by a sequence in which two or more information requests and associated data input fields are presented.

4. The non-transitory computer-readable medium of claim 1, further comprising program code stored thereon which, when executed by a computer, causes the computer to perform the operations of:
recording, for each input form in the set of input forms, each time the input form is selected and provided to the electronic interface; and
recording, for each input form, whether or not data is entered into the data input field and submitted.

5. The non-transitory computer-readable medium of claim 4, further comprising program code stored thereon which, when executed by a computer, causes the computer to perform the operations of:
receiving and storing data entered into the data input field of the selected input form.

6. The non-transitory computer-readable medium of claim 1, wherein the test instruction includes a weight for each input form in the set of input forms, the weight determining a frequency at which an input form is selected.

7. The non-transitory computer-readable medium of claim 1, wherein the test instruction includes a random selection algorithm.

8. The non-transitory computer-readable medium of claim 1, further comprising program code stored thereon which, when executed by a computer, causes the computer to perform the operations of:
associating a test identifier with the set of input forms and the test instruction.

9. The non-transitory computer-readable medium of claim 8, wherein the request includes the test identifier.

10. The non-transitory computer-readable medium of claim 8, further comprising program code stored thereon which, when executed by a computer, causes the computer to perform the operations of:
modifying input forms included in the set of input forms without modifying the associated test identifier.

11. The non-transitory computer-readable medium of claim 8, further comprising program code stored thereon which, when executed by a computer, causes the computer to perform the operations of:
modifying the test instruction without modifying the associated test identifier.

12. The non-transitory computer-readable medium of claim 8, wherein the test identifier is a Javascript tag.

13. The non-transitory computer-readable medium of claim 8, further comprising program code stored thereon which, when executed by a computer, causes the computer to perform the operations of:
recording, for each input form in the set of input forms, each time the input form is selected and provided to the electronic interface and the test identifier.

14. The non-transitory computer-readable medium of claim 8, further comprising program code stored thereon which, when executed by a computer, causes the computer to perform the operations of:
recording, for each input form, whether or not data is entered into data input field and submitted and the test identifier.

15. The non-transitory computer-readable medium of claim 1, further comprising program code stored thereon which, when executed by a computer, causes the computer to perform the operations of:
determining a response ratio for each input form of the set of input forms, wherein the response ratio is a ratio of a number of times data is entered into the data input field and submitted for an individual input form to a number of times the individual input form is displayed.

16. The non-transitory computer-readable medium of claim 1, further comprising program code stored thereon which, when executed by a computer, causes the computer to perform the operations of:
providing a user interface that allows a user to generate one or more input forms, choose the set of input forms, and generate the test instruction for the set of input forms.

17. The non-transitory computer-readable medium of claim 1, wherein the electronic interface comprises a web page.

18. A lead generation system comprising:
one or more processors;
a memory accessible by the one or more processors; and
a test configuration function using the one or more processors and memory, the test configuration function including a set of input forms for display on an electronic interface, each input form including at least one information request and an associated data input field, wherein each input form of the set of input forms differs from all the other input forms of the set of input forms, the test configuration function configured to, in response to a request to display an input form on the electronic interface, select an input form from among the set of input forms, the test configuration function varying which form of the set of input forms is selected in response to separate requests based on a test instruction.

19. The lead generation system of claim 18, further comprising:
a database configured to record, for each input form in the set of input forms, a number of times the input form is displayed and a number of times data is entered and submitted via the data input field.

20. The lead generation system of claim 18, wherein each input form of the set of input forms differs by the at least one information request and associated data input field.

21. The lead generation system of claim 18, further comprising a test identifier associated with the test configuration function, wherein the request to display an input form includes the test identifier.

22. The lead generation system of claim 21, further comprising:
a database configured to record, for each input form in the set of input forms, a number of times the input form is displayed and a number of times data is entered and submitted via the data input field and the associated test identifier.

23. The lead generation system of claim 18, wherein the test instruction includes an algorithm, and wherein each input form of the set of input forms has an associated weight, the weight determining a frequency at which an input form is selected.

24. A computer implemented method for lead generation, the method comprising:
receiving a request from an electronic interface for an input form for display on the electronic interface, each input form including at least one information request and an associated data input field; and
selecting the input form for display on the electronic interface from among a set of input forms, wherein each input form of the set of input forms differs from all the other input forms of the set of input forms, and which input form of the set of input forms is selected in response to separate requests for input forms is varied based on a test instruction.

25. The method of claim 24, wherein each input form of the set of input forms differs by the at least one information request and associated data input field.

26. The method of claim 24, wherein the test instruction includes an algorithm and a weight associated with each input form, the weight determining a frequency with which each input form of the set of input forms is selected.

27. The method of claim 24, further comprising:
recording, for each input form in the set of input forms, each time the input form is selected and provided to the electronic interface; and
recording, for each input form, whether or not data is entered into the data input field and submitted.

28. The method of claim 24, further comprising:
associating a test identifier with the test instruction and set of input forms, wherein the request includes the test identifier.

29. The method of claim 28, further comprising inserting the test identifier into a controlling system for the electronic interface.

30. The method of claim 29, wherein the controlling system is a computer hosting a web site and the test identifier is a Javascript tag embedded into the web site.

31. A computer-implemented method for lead generation, the method including:
in response to a request from an electronic interface, providing an input form to the electronic interface, the input form including an information request and associated data input field,
wherein the input form provided in response to the request has been tested using a test function in which different input forms of a set including the input form, each input form in the set having different information requests and associated data input fields, were provided in response to separate requests based on a test instruction.

32. A non-transitory computer-readable medium comprising program code stored thereon, the program code, when executed by a computer, causes the computer to perform the operations of:
sending a request for an input form from an electronic interface, wherein the input form includes an information request and associated data input field for display on the electronic interface; and
receiving the input form in response to the request, wherein the input form received in response to the request was selected from among a set of input forms using a test instruction.

33. The non-transitory computer-readable medium of claim 32, wherein the program code includes a test identifier associated with the set of input forms, and sending the request includes sending the test identifier.

34. The non-transitory computer-readable medium of claim 33, wherein the test identifier is a Javascript tag.

35. A non-transitory computer-readable medium comprising program code stored thereon, which is accessible to a user controlling a customer interface, the program code, when executed by a computer, causes the computer to perform the operations of:
assigning one or more different input forms to a test configuration function, each input form including at least one information request and an associated data input field for display on the customer interface; and
assigning one or more test instructions to the test configuration function, the test instructions varying which input form of the different input forms assigned to the test configuration is selected in response to separate input form requests from the customer interface.

36. The non-transitory computer-readable medium of claim 35, further comprising program code stored thereon which, when executed by a computer, causes the computer to perform the operations of:
creating a test identifier associated with the test configuration function.

37. The non-transitory computer-readable medium of claim 36, wherein the test identifier is a Javascript tag.

38. The non-transitory computer-readable medium of claim 36, further comprising program code stored thereon which, when executed by a computer, causes the computer to perform the operations of:
modifying the input forms assigned to the test configuration function without modifying the test identifier.

39. The non-transitory computer-readable medium of claim 36, further comprising program code stored thereon which, when executed by a computer, causes the computer to perform the operations of:
modifying the test instruction assigned to the test configuration function without modifying the test identifier.
